(19) United States
(12) Patent Application Publication
(10) Pub. No.: US 2011/0301066 A1
(43) Pub. Date: Dec. 8, 2011

(54) ADHESION LAYER ENHANCEMENT OF PLASMONIC FLUORESCENCE

(76) Inventor: Steven M. Blair, Salt Lake City, UT (US)

(21) Appl. No.: 12/793,883

(22) Filed: Jun. 4, 2010

(51) Int. Cl. C40B 60/00; H01S 3/08; B82Y 20/00

(52) U.S. Cl. 506/33; 359/346; 977/902; 977/755

(57) ABSTRACT

A light enhancement device includes at least two layers disposed over the substrate, including an adhesion layer disposed closer to the substrate than a metallic layer. At least one nanocavity extends into the metallic layer. The thickness of the adhesion layer and the diameter of the cavity have a ratio that is in the range of approximately 1:4 to 1:100. Capture molecules can be disposed within the nanocavities.

### RELATED APPLICATIONS

This is related to U.S. patent application Ser. No. 11/497,581, filed on Aug. 2, 2006, which is hereby incorporated herein by reference in its entirety.

This is related to U.S. patent application Ser. No. 12/603,242, filed on Oct. 21, 2009, which is hereby incorporated herein by reference in its entirety.

### STATEMENT REGARDING FEDERALLY SPONSORED RESEARCH OR DEVELOPMENT

This invention was made in part with Government support under Contract Nos. ECS-0622225 and ECS-0637121 awarded by the U.S. National Science Foundation. The Government has certain rights in this invention.

### BACKGROUND

1. Field of the Invention

The present invention relates generally to light enhancement devices or detection enhancement devices for a biological assay.

2. Related Art

It has been demonstrated that when illuminated with light, metallic cavity arrays support extraordinary transmission with resonances at specific frequencies, which are strongly related to the cavity array periodicity. See T. W. Ebbesen, H. J. Lezec, H. F. Gaemi, T. Thio, and P. A. Wolff, “Extraordinary optical transmission through sub-wavelength cavity arrays,” Nature (London) 391, 667 (1998). Several models have been suggested to describe this phenomenon. See L. Martin-Moreno, F. J. Garcia-Vidal, H. J. Lezec, K. M. Pellerin, T. Thio, J. B. Pendry, and T. W. Ebbesen, “Theory of Extraordinary Optical Transmission through Subwavelength Cavity Arrays,” Phys. Rev. Lett. 86, 1114 (2001); C. Genet, M. P. van Exter, J. P. Woerdman, “Fano-type interpretation of red shifts and red tails in cavity array transmission spectra,” Opt. Commun. 225, 331 (2003); and H. J. Lezec, T. Thio, “Diffracted evanescent wave model for enhanced and suppressed optical transmission through subwavelength cavity arrays,” Opt. Exp. 12, 3629 (2004). Most of these invoke the role of surface plasmon polaritons (SPPs). SPPs are surface electromagnetic waves formed by collective oscillation of electrons at a metal-dielectric interface. See H. Raether, Surface Plasmons on Smooth and Rough Surfaces and on Gratings, (Springer-Verlag, Berlin, 1988). These models indicate that the extraordinary transmission occurs when the incident excitation matches the surface plasmon resonances. The light is strongly localized on subwavelength scales as plasmonic excitations and a resonance effect is accompanied by field enhancement.

One of the main possible areas of use for such metallic cavity arrays is in the microarray diagnostic technologies. The substrates generally used in a microarray platform consist of an array of microscopic spots of immobilized DNA oligonucleotides, peptides, or proteins. The complementary or desired sequence of another molecule, such as ssDNA attached or tagged with a fluorescent molecule (often with absorption maxima at 488 nm, 532 nm and 635 nm) hybridizes to complementary probes on the substrate. After the hybridization reaction these substrates are excited by laser sources corresponding to the fluorescent molecules used, and fluorescence intensity is read or scanned with a microarray scanner. The concentrations of DNA oligomers immobilized on such substrates are typically in the nanomolar to picomolar ranges. The metallic cavity arrays under illumination redistribute light inside the cavities through the excitation of surface plasmons thereby increasing the local intensity. By immobilizing the DNA oligonucleotides inside the cavities and using them as tiny reaction chambers for hybridization, it is possible to take advantage of the local intensity enhancements for improving the emitted fluorescence intensity. See M. J. Heller, “DNA microarray technologies: Devices, systems and applications,” Annu. Rev. Biomed. Eng., 4, 129 (2002).; Y. Liu, F Mandavi, and S. Blair “Enhanced Fluorescence Transduction Properties of Metallic cavity Arrays,” IEEE J. Selected Topics in Quantum Electronic 11, 778 (2005); and S. Fore, Y, Yuen, L. Hesselink, T. Huser, “Pulsed-interleaved excitation FRET measurements on single duplex DNA molecules inside C-shaped cavities” Nano. Lett. 7 1749 (2007).

Plasmonic component, such as nanoantennas, have gained great interest in recent years. Gold is widely used to fabricate plasmonic components, but a supplementary adhesion layer (generally made of chromium or titanium) is needed to ensure firm contact between the gold film and the substrate. However, detailed understanding is still lacking regarding the role of this adhesion layer on the plasmonic resonances. It has been experimentally observed that a thin intermediate chromium or titanium layer shifts and broadens the surface plasmon resonance in the case of a flat interface or of gold nanodiscs. See 1) Neff, H.; Zong, W.; Lima, A. M. N.; Borre, M.; Holzhuter, G. Optical Properties and Instrumental Performance of Thin Gold Films near the Surface Plasmon Resonance. Thin Solid Films 2006, 496, 688-697; 2) Sexton, B. A.; Feltis, B. N.; Davis, T. J. Characterisation of Gold Surface Plasmon Resonance Sensor Substrates. Sens. Actuators, A 2008, 141, 471-475; 3) Barchiesi, D.; Maclas, D.; Belmar-Letellier, L.; van Labeke, D.; Lamy de la Chapelle, M.; Toury, T.; Kremer, E.; Moreau, L.; Grosges, T. Plasmonics: Influence of the Intermediate (or Stick) Layer on the Efficiency of Sensors. AppL Phys. B 2008, 93, 177181; and 4) Kim, J.; Cho, K.; Lee, K.-S. Effect of Adhesion Layer on the Optical Scattering Properties of Plasmonic Au Nanodisc. J. Korean Inst. Met. Mater. 2008, 46, 464-470. The magnitude of the resonance has also been found to decrease when the thickness of the adhesion layer increases. The case of resonant bowtie nanoantennas has been recently numerically modeled. See Jiao, X.; Goeckeritz, J.; Blair, S.; Oldham, M. Localization of Near-Field Resonances in Bowtie Antennae: Influence of Adhesion Layers. Plasmonics 2009, 4, 37-50; and WO 2009/149125. It was found that the influence of adhesion layers lies on the complex dielectric constant of the material. For dielectric adhesion layers, the influence of the refractive index causes the plasmonic resonance to red shift and decrease in strength. It was also found to modify the field localization within the nanoantenna by pushing the high-intensity region to the top of the structure when illuminated from below. For metal adhesion layers, the intrinsic absorption quenches the resonance at the bottom of the structure, while causing the resonances within the gap to red shift from top to bottom.

### SUMMARY OF THE INVENTION

It has been recognized that it would be advantageous to bridge the gap between numerical modeling and experimental observations of the influence of adhesion layers in plasmonics. In addition, it has been recognized that it would be advantageous to develop a light enhancement device and/or detection enhancement device for a biological assay.

The invention provides a detection-enhancement device for biological assay including a metallic layer disposed over a substrate. An array of multiple nanocavities extend into the metallic layer. The nanocavities each have a bottom and a sidewall laterally circumscribing each nanocavity. Capture molecules are disposed within the nanocavities. The metallic layer has a thickness between 50 to 200 nanometers, and the nanocavities have a lateral dimension of 65 to 190 nanometers. An adhesion layer adheres the metallic layer to the substrate. A thickness of the adhesion layer and the diameter of the cavity have a ratio in the range of 1:4 to 1:100.

In addition, the invention provides a light enhancement device includes at least two layers disposed over a substrate, comprising at least a first layer and a second layer. The first layer is disposed closer to the substrate than the second layer. At least one nanocavity extends into the second layer. The first layer has a first layer thickness and a material, the second layer has a second layer thickness and a material, and the at least one cavity has a cavity diameter and a cavity shape adapted to enhance transmission of light through the at least one nanocavity. The thickness of the first layer and the diameter of the cavity have a ratio that is in the range of approximately 1:4 to 1:100.

In addition, the invention provides a light enhancement device includes at least two layers disposed over a substrate, comprising at least a first layer and a second layer. The first layer is disposed closer to the substrate than the second layer. An array of multiple nanocavities extends into the second layer. The first layer has a first layer thickness and a material, the second layer has a second layer thickness and a material, the at least one cavity has a cavity diameter and a cavity shape adapted to enhance transmission of light through the at least one nanocavity. The first layer causes an improvement in light transmission by a factor of at least 3.

Furthermore, the invention provides a detection-enhancement device for biological assay, comprising a metallic layer disposed over a substrate. An array of multiple nanocavities extends into the metallic layer. The nanocavities each have a bottom and a sidewall laterally circumscribing each nanocavity. Capture molecules are disposed within the nanocavities. The metallic layer has a thickness between 50 to 200 nanometers, and the nanocavities have a lateral dimension of 65 to 190 nanometers. An adhesion layer adheres the metallic layer to the substrate. A blocking layer is disposed over the metallic layer includes a material to resist light transmitting through the metallic layer.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1a is a cross-sectional side schematic view of a light enhancement or detection enhancement device for a biological assay in accordance with an embodiment of the present invention.

FIG. 1b is a schematic view of an experimental configuration.

FIG. 2a is a graph of count rate per molecule versus the excitation power within a single 120 nm aperture with different adhesion layers. Markers are experimental data, solid lines are numerical fits. Fitting parameters are summarized in Table 1.

FIG. 2b is a graph of fluorescence rate enhancement in the regime below saturation deduced from the numerical fits in FIG. 2a.

FIG. 3a is a graph of normalized fluorescence decay traces measured in open solution (black dots) and in single 120 nm apertures with 10 nm Ti or TiO2 adhesion layer. Dots are experimental data, lines are numerical fits. The other adhesion layers used in this study resulted in traces almost identical to the one of the TiO2 case; they are therefore not represented here to maintain clarity.

FIG. 3b is a graph of fluorescence lifetime reduction as compared to molecules in open solution for the different adhesion layers.

FIG. 4a is a graph of contributions of excitation to the fluorescence enhancement found for different adhesion layers. Bars are experimental data, empty circles are for numerical computations.

FIG. 4b is a graph of Contributions of emission gains to the fluorescence enhancement found for different adhesion layers. Bars are experimental data, empty circles are for numerical computations.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

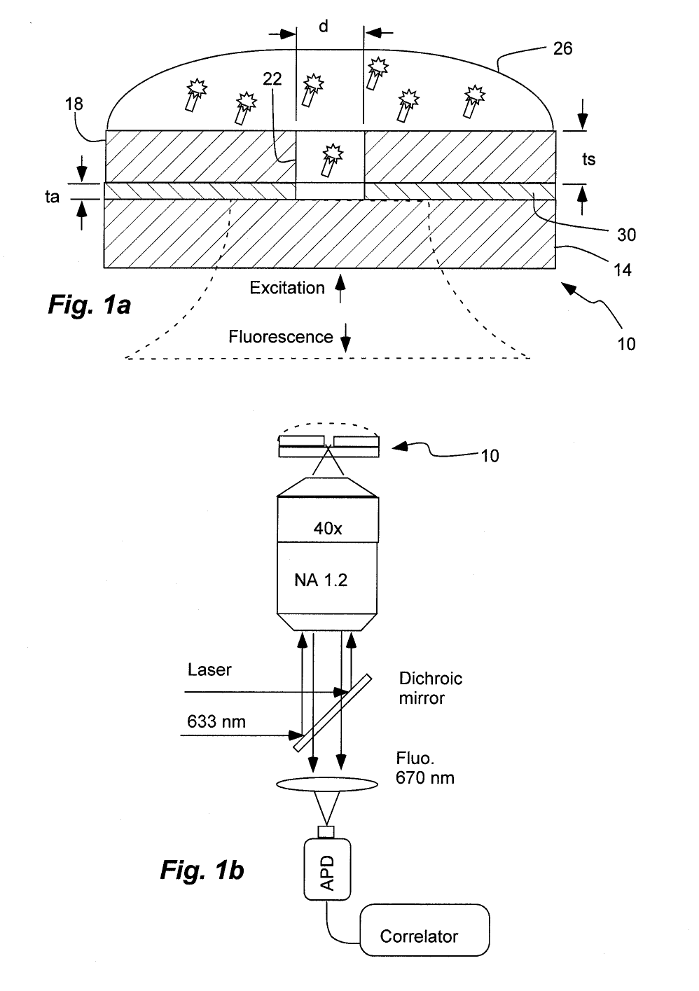

As illustrated in FIG. 1a, a light enhancement device and/or detection enhancement device for a biological assay, indicated generally at 10, in an example implementation in accordance with the invention is shown. The device includes a substrate 14 with a metallic layer (or second layer) 18 disposed over the substrate. The substrate 14 can be or can be formed of glass, quartz, another optically suitable (e.g., transparent) inorganic material, an optical plastic, a combination of any of the foregoing (as is the case in so-called “thin-film” waveguides, which include multiple layers), etc. The metallic layer 18 can be or can include gold, silver, aluminum, their alloys or combinations thereof. The metallic layer or film can be applied to at least one surface of the substrate by deposition techniques, lamination processes, etc. In one aspect, the metallic layer 18 can have a thickness ts between 50 to 200 nanometers. In another aspect, the thickness ts of the metallic layer can be 75 to 200 nanometers. In another aspect, the thickness ts of the metallic layer can be 75 to 125 nanometers. In another aspect, the thickness ts of the metallic layer can be less than 75 nanometers.

At least one nanocavity or an array of multiple nanocavities, represented by 22, extend into the metallic layer 18, and can extend all the way to the substrate 14. The nanocavities 22 each having a bottom and a sidewall laterally circumscribing or surrounding each nanocavity. Thus, the nanocavity is enclosed on the bottom and lateral sides, while being open at the top. The nanocavities can be formed in the metallic film by suitable processes (e.g., mask and lift-off processes (such as those used in semiconductor device fabrication), mask and etch processes (such as those used in semiconductor device fabrication), with a laser, etc.). The nanocavities may extend completely through the metallic film, with the underlying substrate being exposed therethrough. A lateral dimension (e.g., diameter) of each nanocavity may be about the same as the thickness of the metallic layer, although lateral nanocavity dimensions may differ from the thickness of the metallic layer. In one aspect, the nanocavities can have a lateral dimension d or diameter of 65 to 190 nanometers. In another aspect, the dimension or diameter d of the nanocavities can be about 100 to 140 nanometers. In another aspect, the dimension or diameter d of the nanocavities can be about 65 to 85 nanometers. In another aspect, the dimension or diameter d of the nanocavities can be about 120 to 160 nanometers. In another aspect, the dimension or diameter d of the nanocavities can be about 150 to 190 nanometers.

Nanocavities of virtually any shape may be formed. Examples of nanocavity shapes include, but are not limited to, round (e.g., circular, oval, elliptical, egg-shaped, etc.), quadrilateral (e.g., square, rectangular, parallelogram, trapezoidal, etc.), triangular, and other polygonal shapes. The nanocavities that are formed in a metallic film may all have substantially the same shapes and dimensions, or a variety of shapes and/or dimensions of nanocavities may be included in the metallic film of a biomolecular assay.

The nanocavities may be arranged in such a way that facilitates the coupling of incident light into surface modes, or waves, on the metallic film, which surface modes can constructively interfere within the nanocavities. For example, when incident light is to be directed from the substrate, or back side of the biomolecular assay, and fluorescence is to be detected at a location adjacent to the opposite, top surface of the biomolecular assay (i.e., the surface by which the metallic film is carried), the metallic film prevents excitation of fluorophores in the bulk solution 26, which is located over the metallic substrate. As another example, when incident light is directed toward the biomolecular assay from a location over the metallic film and detection occurs at a location adjacent to the back side of the substrate, although marker molecules that remain within solution may undergo a change in state (e.g., fluorescence by fluorescent marker molecules), the marker molecules that remain in solution over the metallic film remain substantially undetected. This is because light emitted from a location above the metallic film does not pass through the metallic film and since the size of each nanocavity may be too small for fluorescent light emitted from locations over the surface of the metallic film to pass therethrough. Fluorescent light generated within the nanocavities does exit the nanocavities, however, and is enhanced by the materials from which the nanocavities are formed, as well as by the configurations and dimensions of the nanocavities.

In specific applications, however, fluorescence signals originating from fluorescent species lying outside of the cavity may be a concern. For example, these signals may increase background or noise of an assay and thus compromise the sensitivity and/or precision of the assay. Partial or complete isolation of fluorescence signals originating from fluorescent species lying outside of the cavity can be obtained by either narrowing the fluorescence collection angle or by passivating the surfaces of the metallic film.

The shapes of the nanocavities may be configured to optimize signal amplification. It has been discovered that nanocavities of a variety of shapes, including circular, square, and triangular, provide a good degree of radiative, or signal, enhancement, depending upon the dimensions (e.g., diameters of circular nanocavities, edge lengths of square and triangular nanocavities, etc.) of the nanocavities. Square nanocavities may provide better signal enhancement than circular nanocavities, while triangular nanocavities may provide even greater signal enhancement.

Surfaces of the biomolecular substrate may be passivated to prevent capture molecules (e.g, bait molecules) from adhering, or being immobilized, to undesired locations thereof. The surfaces of the metallic film may be passivated, for example, with polyethylene glycol (PEG)-thiol, another metal (e.g., gold)-selective thiol molecule, or any other material that prevents capture molecules from being immobilized to the metallic film, or reduce immobilization of capture molecules to the metallic film. Thus, the capture molecules are instead immobilized to the surface of the substrate exposed to and located within or adjacent to the nanocavities. Alternatively, the exposed surfaces of the substrate may be passivated (e.g., with PEG silane) to prevent capture molecules from adhering to the substrate and, rather, causing the capture molecules to be immobilized only to the metallic surfaces. As another alternative, a major surface of the metallic film may be covered with a coating film (e.g., another transparent film), and the exposed surfaces of the coating film, as well as surfaces of the substrate that are exposed through the coating film and the metallic film, may be passivated, causing capture molecules to adhere only to the unpassivated exposed edges of the metallic film, which form part of the surface of each nanocavity.

In addition, capture molecules can be disposed within the nanocavities. Capture molecules are introduced into the nanocavities and immobilized to surfaces of the nanocavities, the substrate, or both. The capture molecules are specific for one or more analytes of interest. Target or capture molecules (e.g., probe oligonucleotides) of an assay may reside on the sidewalls, the bottom surfaces, or both the sidewalls and the bottom surfaces of the nanocavities. One molecular species (i.e., the target oligonucleotides or analyte, which is fluorescently labeled) specifically bind to the capture oligonucleotides through hybridization. An optically-transduced, real-time signal in proportion to the number of bound target oligonucleotides are detected from the side of the sensor array opposite to the side on which the sample solution is introduced, thereby providing isolation from unbound species, which may represent a significant fraction of the detected signal in a washless assay. Fluorescence from unbound species do not penetrate the opaque metal except at the nanocavities. By measuring the hybridization kinetics in real-time, nonspecific binding may be factored out as well.

To prevent capture molecules from binding to undesired locations of the nanocavities, the surfaces of the metallic film or the surface of the substrate may be passivated. For example, a surface of the metallic film may be passivated with polyethylene glycol (PEG)-thiol. Thus, the probe oligonucleotides (i.e., capture molecules) are selectively attached to the bottoms of the nanocavities. On the other hand, the exposed surface of the substrate may be passivated (e.g., with PEG silane) to prevent capture molecules from adhering to the surface of the substrate and, rather, causing the capture molecules to be selectively attached to the sidewalls of the nanocavities. Alternatively, to facilitate coupling of the capture molecules to the sidewalls of the nanocavities, a thin (˜20 nm) cover layer of Si02 is deposited to cover the top metal surface. With this structure, the only exposed substrate surface is the inside walls of the nanocavities, to which selective derivatization of capture molecules is performed. A layer (e.g., 5 nm) of Al or Cr, may be used to promote adhesion of the SiO2 layer. The passivation layer disposed over the metallic layer is capable of preventing adsorption of a molecule of interest onto the metallic layer.

Surfaces of nanocavity substrates may also be modified for covalent or noncovalent immobilization of capture molecules. For example, Si02 and Si3N4 surfaces of nanocavity substrates may be modified with a reactive species, e.g., epoxysilane. After surface modification with a reactive species, coating of the capture molecules may be performed. For example, amine-modified nucleic acid probes may be spotted on epoxysilane-modified surfaces, and reactions of the amine groups and the epoxy groups cause the amine-modified nucleic acid probes covalently linked to the surface of the substrate.

In addition, blocking layer of lossy material, such Cr, Ti and/or Al, can be disposed on or over the metal layer to resist light from transmitting through the device and/or metallic layer and into the solution.

Furthermore, an adhesion layer (or first layer) 30 adheres the metallic layer 18 to the substrate 14. The adhesion layer is disposed closer to the substrate than the metallic layer. The nanocavities can extend through the adhesion layer to the substrate. The adhesion layer has a first layer thickness to and a material, the metallic layer has a second layer thickness is and a material, and the at least one cavity has a cavity diameter d and a cavity shape adapted to enhance transmission of light through the at least one nanocavity; and/or to enhance a signal representative of an amount of at least one analyte present in a sample. As discussed above, it has been found that the plasmonic enhancement of single-molecule fluorescence has a strong dependence on the nature, such as material and thickness, of the adhesion layer. In one aspect, the adhesion layer can be or can include titanium dioxide TiO2. In another aspect, the adhesion layer can be or can include titanium dioxide and chromium oxide and combinations thereof. In one aspect, the thickness ta of the adhesion layer 30 and the diameter d of the cavity 22 can have a ratio in the range of 1:4 to 1:100. In another aspect, the thickness ta of the adhesion layer 30 and the diameter d of the cavity 22 can have a ratio in the range of 1:4 to 1:40. In another aspect, the thickness ta of the adhesion layer 30 and the diameter d of the cavity 22 can have a ratio in the range of 1:4 to 1:30. In another aspect, the thickness ta of the adhesion layer 30 and the diameter d of the cavity 22 can have a ratio in the range of 1:5 to 1:30. In another aspect, the metallic layer can be or can include aluminum, the thickness ta of the adhesion layer 30 and the diameter d of the cavity 22 can have a ratio in the range of 1:4 to 1:40. The thickness ta of the adhesion layer 30 can be between 2 to 15 nanometers. In one aspect, the adhesion layer causes an improvement in light transmission by a factor of at least 3.

In addition, the at least one cavity can comprise a tapered sidewall with an angle. The angle of the tapered sidewall with respect to a surface parallel to the substrate can be sufficiently different than 90° to provide an enhancement of the transmission of light through the at least one cavity, an enhancement of the intensity of light within the at least one cavity, or both, that is greater than the enhancement if the angle was 90°. Furthermore, at least one change in a sidewall within the at least one cavity can including a change in angle, a change in material, a change in width, or combinations thereof sufficient to provide an enhancement of the transmission of light through the at least one cavity, an enhancement of the intensity of light within the at least one nanocavity, or both, that is greater than the enhancement without the change in the sidewall.

The biomolecular assay may be used in an assay system or technique that employs fluorescence detection techniques. Such a system also includes a source of electromagnetic radiation and a detector. The source is configured to emit electromagnetic radiation of one or more wavelengths, or “incident light,” that excites fluorescent dye molecules that are to be used in the system, and oriented to direct the radiation onto the nanocavities or into the substrate, The incident light may be in the form of light transmitted from a source, an evanescent field generated as light is directed into and internally reflected within a substrate or transparent film that comprises a waveguide, or a combination thereof. Radiation can penetrate the nanocavities directly and, optionally, due to constructive interference that may occur because of the arrangement of the nanocavities, thereby exciting species within the nanocavities, or radiation may be internally reflected within the substrate, generating an evanescent field at one or more surfaces thereof. The incident light excites fluorescent dye molecules that are immobilized (directly or indirectly, depending upon the assay binding technique (e.g., a sandwich-type assay, a binding competition assay, etc.) employed relative to capture molecules within the nanocavities. Fluorescent dye molecules within the nanocavities are excited and, thus, emit electromagnetic radiation. The electromagnetic radiation is enhanced by the nanocavities and the metallic substrate. It is then detected by the detector. An aperture associated with the detector may tailor the angle of a collection cone of radiation emitted by the fluorescent dye molecules.

The biomolecular assay may be used with known mass detection processes. As an example, a reference analyte of known concentration and analyte within a sample, which has an unknown concentration, may be labeled with different marker molecules (e.g., fluorescent molecules that emit different wavelengths, or colors, of light) and their binding to capture molecules that have been immobilized within the nanocavities compared to provide an indication of the amount of analyte in the sample. The affinities of the reference analyte and the sample analyte for the capture molecule, which may be known, may be the same or different.

### EXAMPLES

Referring to FIG. 1b, an apparatus and technique is illustrated to characterize the fluorescence emission. The apparatus and technique can characterize the fluorescence within single nanometric apertures. For purposes of description, a single nanocavity with a diameter of 120 nm is formed in a gold film with a thickness of 200 nm. This nanoaperture structure offers a reliable test bench and can be reproducibly fabricated with robust techniques. Genet, C.; Ebbesen, T. W. Light in Tiny Holes. Nature 2007, 445, 39-46. Lenne, P. F.; Rigneault, H.; Marguet, D.; Wenger, J. Fluorescence Fluctuations Analysis in Nanoapertures: Physical Concepts and Biological Applications. Histochem. Cell Biol. 2008, 130, 795805. In addition, it has been proven to be a sensitive platform to study enhanced fluorescence emission of single molecules. Gerard, D.; Wenger, J.; Bonod, N.; Popov, E.; Rigneault, H.; Mandavi, F.; Blair, S.; Dintinger, J.; Ebbesen, T. W. Nanoaperture-Enhanced Fluorescence: Towards Higher Detection Rates with Plasmonic Metals. Phys. Rev. B 2008, 77, 045413. Wenger, J.; Gerard, D.; Bonod, N.; Popov, E.; Rigneault, H.; Dintinger, J.; Mahboub, 0.; Ebbesen, T. W. Emission and Excitation Contributions to Enhanced Single Molecule Fluorescence by Gold Nanometric Apertures. Opt. Express 2008, 76, 3008-3020. The influence of different adhesion layers was investigated, namely: 5 nm of chromium or titanium, 10 nm of titanium, and 10 nm of titanium oxide (TiC2) or chromium oxide (Cr203). The aperture diameter was chosen to yield the maximum fluorescence enhancement at 633 nm excitation. For each sample, the fluorescence emission of Alexa Fluor 647 molecules diffusing within the structure was characterized. Wenger, J.; Gerard, D.; Bonod, N.; Popov, E.; Rigneault, H.; Dintinger, J.; Mahboub, 0.; Ebbesen, T. W. Emission and Excitation Contributions to Enhanced Single Molecule Fluorescence by Gold Nanometric Apertures. Opt. Express 2008, 76, 3008-3020. This method relies on a combination of fluorescence correlation spectroscopy (FCS) with fluorescence time-correlated lifetime measurements. It specifically allows one to detail the influence of the nanostructure on the molecular emission and quantifies the respective weights of excitation and emission contributions to the observed enhanced fluorescence.

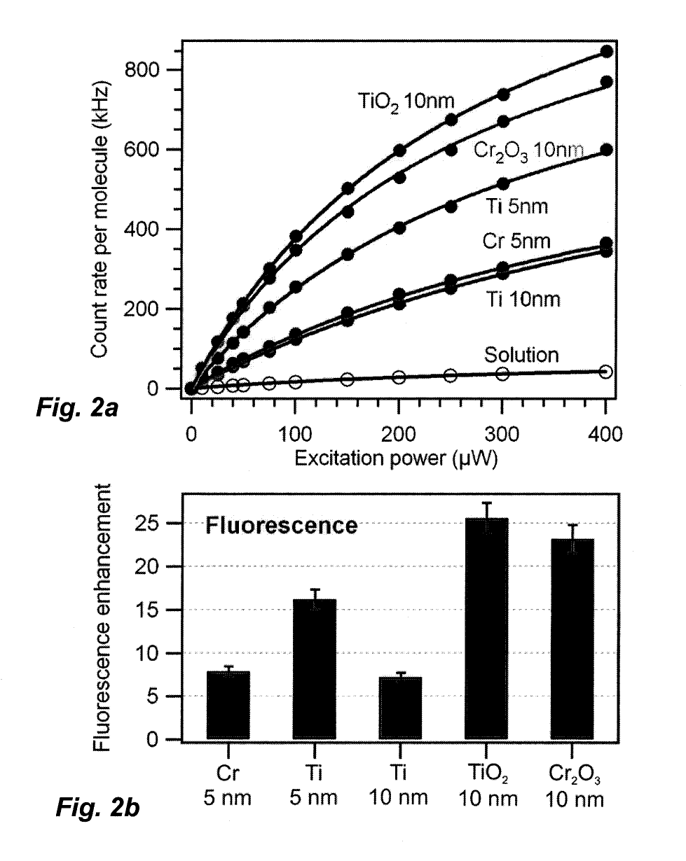

A set of FCS measurements were performed while increasing the excitation power from 10 to 400 W (the upper limit was set to avoid damaging the sample and photobleaching the dyes). Each FCS correlation function was analyzed to reliably measure the fluorescence count rate per molecule (CRM), as described below. For each excitation power, special care is taken to characterize the level of background noise and the dark state amplitude. Results are summarized in FIG. 2a, in the case of an open solution and in the case of 120 nm apertures with different adhesion layers. It is apparent from this raw data that the nature of the adhesion layer has a dramatic impact on the fluorescence emission. To make this effect appear even clearer, we model this data with the expression of the fluorescence rate given by CRM=A(Ie)/(1+Ie,/Is), where Ie is the excitation intensity, Is the saturation intensity, and A is a constant proportional to the molecular absorption cross section, quantum yield, and setup collection efficiency. Zander, C., Enderlein, J., Keller, R. A., Eds. Single-Molecule Detection in Solution: Methods and Applications; Wiley-VCH: Berlin/New York, 2002. The fitting parameters are summarized in Table 1 and are used hereafter to compare the different adhesion layers.

TABLE 1
Refractive Index (n) and Extinction Coefficient (k) of the Different
Materials Used Here at 633 nm Wavelength, Jiao, X.; Goeckeritz, J.;
Blair, S.; Oldham, M. Localization of Near-Field Resonances in Bowtie
Antennae: Influence of Adhesion Layers. Plasmonics 2009, 4, 37-50.

| material | Cr | Ti | Ti | TiO2 | Cr2O3 | sol |
|---|---|---|---|---|---|---|
| thickness (nm) | 5 | 5 | 10 | 10 | 10 | |
| n | 3.54 | 2.15 | 2.15 | 1.97 | 2.45 | |
| k | 4.36 | 2.92 | 2.92 | 0 | 0.54 | |
| A (kHz/μW) | 1.6 | 3.2 | 1.4 | 5.1 | 4.6 | 0.2 |
| Is(μW) | 480 | 320 | 600 | 280 | 270 | 435 |
| τ(ns) | 0.41 | 0.40 | 0.36 | 0.40 | 0.40 | 0.88 |

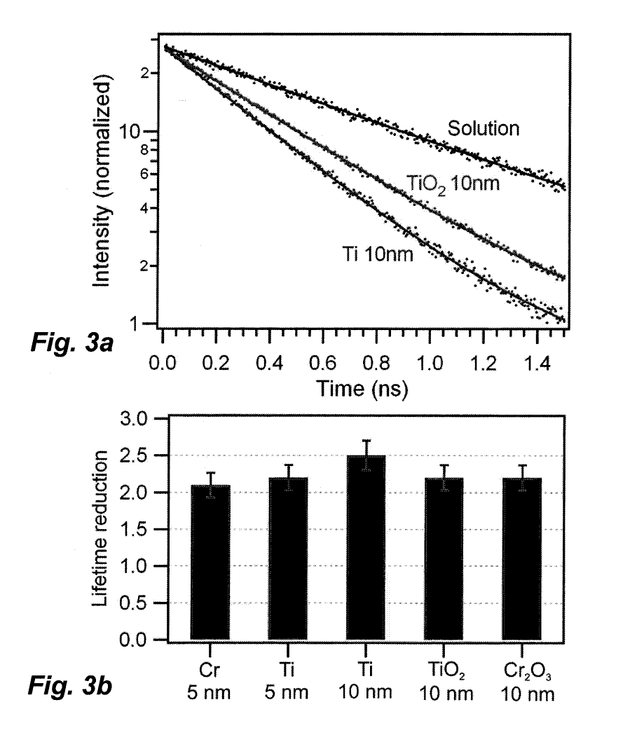

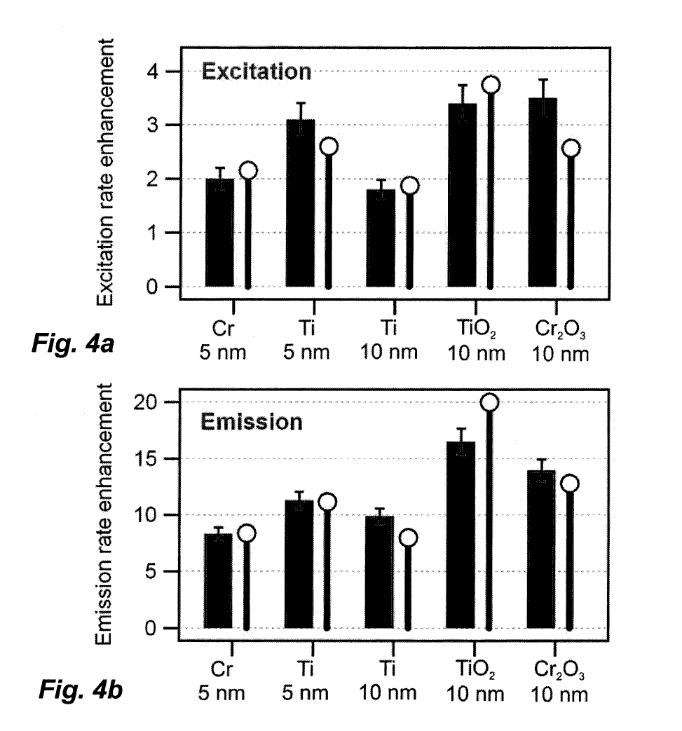

The table also presents the fitting parameters A, Is, for the experimental data in FIG. 3a and the fluorescence lifetime τ in FIG. 4a.

FIG. 2b displays the fluorescence rate enhancement for the different adhesion layers found in the regime below saturation. This factor is defined as the ratio of the detected fluorescence rate per molecule in the aperture with respect to the CRM in open solution taken at the limit of low excitation Ie—0. Practically, it corresponds to the ratio of the A parameters derived from the interpolation of the data curves in FIG. 2a, which are given in Table 1.

A striking 25-fold fluorescence enhancement is found for a 10 nm Ti02 layer and is the highest gain reported to date for Alexa Fluor 647 molecules in a nanoaperture. This value has to be compared to the 7.2 enhancement found instead for a 10 nm Ti layer. Although the same preparation procedures and experimental setup are used, the net difference between the fluorescence signal per emitter can be as large as 3.5 fold. At least seven different apertures are tested for each adhesion layer, with variation in fluorescence count rate between 6 and 8%, which takes into account effects such as dispersion in aperture diameter. The error bars displayed in FIG. 2b indicate the standard deviations of our measurements.

Metallic adhesion layers, such as Cr and Ti, are shown to yield lower overall fluorescence enhancements and greater saturation intensities than dielectric layers. This can be understood as a stronger damping of the plasmonic resonance due to an increased absorption in the adhesion layer and corroborates the conclusion drawn in Jiao, X. (Localization of Near-Field Resonances in Bowtie Antennae: Influence of Adhesion Layers). The negative effect of losses is confirmed by the lower enhancement found for chromium compared to that for titanium at a fixed thickness (chromium's absorption is about three times that of titanium at 633 nm; see Table 1) and by the fact that the fluorescence enhancement increases when the adhesion layer thickness decreases. Last, the damping effect of absorption is also exhibited for dielectrics, with a higher enhancement for titanium oxide (which shows negligible absorption in the visible range) than for chromium oxide (which has some residual absorption at 633 nm). Almost every experimental study of plasmonic nanoantennas skips the issue of the adhesion layer choice and design, while we clearly show here that it has a dramatic influence.

To complete the FCS measurements and fully characterize the fluorescence enhancement phenomenon, we conduct time-correlated single photon counting (TCSPC) experiments to monitor the fluorescence lifetime alteration inside the nanoapertures. These experiments are performed for the same nanoaperture sample and the Alexa Fluor 647 solution. FIG. 3a shows the fluorescence decay curves for molecules in open solution and in single 120 nm apertures with 10 nm Ti or TiO2 adhesion layer. The other adhesion layers used in this study resulted in traces nearly identical to the one of the TiO2 case and are not represented to ease viewing the graphs. The fluorescence decay rate is measured by fitting the data using a single exponential decay model convolved by the calibrated instrument response function. Wenger, J.; Gerard, D.; Bonod, N.; Popov, E.; Rigneault, H.; Dintinger, J.; Mahboub, 0.; Ebbesen, T. W. Emission and Excitation Contributions to Enhanced Single Molecule Fluorescence by Gold Nanometric Apertures. Opt. Express 2008, 76, 3008-3020. This yields the fluorescence lifetime reduction normalized to the open solution case displayed in FIG. 3b. Interestingly, this factor appears almost independent of the adhesion layer, showing that the near-field molecular decay routes in the nanoaperture are dominated by the gold structure, not by the adhesion layer. However, the coupling of the fluorescence radiation to the far-field is affected by the adhesion layer, as shown on FIG. 2a and discussed hereafter.

Different effects can lead to an enhancement of the fluorescence signal of a single molecule: (i) local increase in the excitation intensity, (ii) increases in the emitter's radiative rate and quantum efficiency, and (iii) modification of the emitter's radiation pattern, giving a higher emission directionality toward the detectors. Determining the relative influence of these effects is a delicate task, which can be addressed by combining FCS with fluorescence lifetime measurements. As discussed in the Methods section, the gain in emission, ηem, is derived from the value of the fluorescence enhancement in the saturation regime, which we obtain from the asymptotic interpolation of the data points in FIG. 3a at the limit where Ie→∞. The gain in excitation intensity, ηexc equals the fluorescence enhancement in the low excitation regime divided by the ratio of the emission gain by the total decay rate alteration: ηexc=ηF/(ηem/ηtot).

This procedure yields the experimental estimates of the excitation and emission gains for the different adhesion layers displayed in FIGS. 4a and b. The gain in excitation intensity can be understood as a better coupling of energy inside the nanostructure, while the gain in emission has to be related to a better outcoupling of the energy stored in the dipole's near-field to the detected far-field radiation. Due to the small Stokes shift between the excitation and emission wavelengths of Alexa Fluor 647, the reciprocity theorem holds and, consequently, both excitation and emission phenomena influence the overall gain in fluorescence and show strong variations with the nature of the adhesion layer used. Absorption in metallic adhesion layers yields lower gains than dielectric layers for both excitation and emission. These data confirm that any increase in absorption losses due to the material's properties or an increased thickness results in a damping of the near- to far-field coupling at the nanoaperture.

To supplement this experimental evidence, we conduct a numerical analysis based on the finite element method, as discussed below. This method allows one to separately compute the enhancements in excitation intensity and emission rate, which both contribute to the overall gain in the fluorescence signal. The increase of the excitation intensity inside the aperture is computed from the average intensity measured with and without the nanostructure at a plane located 20 nm inside the aperture. For the emission calculations, we compute the radiative emission through the glass side by integrating the z-component of Poynting's vector across a plane located 20 nm below the metal surface for single dipoles located in different positions and orientations inside the aperture, as discussed below. Results of numerical simulations for excitation and emission are displayed in FIGS. 4a and b for the different adhesion layers (empty markers). They are remarkably consistent with the experimental data and confirm the crucial influence of the adhesion layer on both excitation and emission gains in the nanostructure. Interestingly, this method allows one to predict the maximum fluorescence enhancement for gold only with no adhesion layer. We obtain an optimum fluorescence enhancement of 28 for Alexa Fluor 647 molecules, which is about 10% higher than with the 10 nm TiO2 layer. This confirms that titanium oxide is the material of choice for practical plasmonic enhancement applications.

We experimentally and numerically study the influence of the adhesion layer commonly used to ensure firm contact between a gold film and underlying glass substrate in plasmonic nanoantennas. A single aperture milled in the metal film with 120 nm diameter forms a reliable structure to investigate the effects of the adhesion layer on the fluorescence enhancement of single molecules. Although the same preparation procedures and experimental setup are used, we show that the nature of the adhesion layer (permittivity and thickness) has a dramatic impact on the fluorescence signal per molecule with a difference up to a factor of 4. By combining FCS and fluorescence lifetime measurements, we detail the respective contributions of excitation and emission gains to the observed enhanced fluorescence. Any increase in the absorption losses due to the adhesion layer material's properties or increased thickness is shown to yield lower enhancements, which we relate to a damping of the near- to far-field coupling at the nanoaperture. The experimental data are sustained by numerical simulations using finite element method. To our knowledge, this is the first experimental report of the strong dependence of the fluorescence gain on the nature of the adhesion layer. Clearly, one has to consider the role of the adhesion layer while designing nanoantennas for high-efficiency single-molecule analysis based on either fluorescence or Raman scattering, 10 nm of titanium oxide being the optimal choice based upon our study.

### Methods

Nanoaperture Fabrication. All metal and dielectric films are deposited using reactive DC magnetron sputtering in the same chamber. The gold film thickness of 200 nm was chosen to be optically opaque and isolate the molecules diffusing in the aperture from the pool of molecules lying above the structure. Adhesion between the gold film and the 150 μm thick glass substrate is ensured by a layer of 5 nm of chromium or titanium, 10 nm of titanium, or 10 nm of titanium oxide (TiO2) or chromium oxide (Cr2O3). The oxides' adhesion layers are deposited using the same metal targets, but under partial oxygen pressure. Thickness control is maintained by a cluster of piezoelectric monitors. We relied on calibration of the deposition process using quartz crystal monitors and test samples. Therefore, we estimate no more than 20% error in the adhesion layer thickness. Similar adhesion properties were found for these different layers. Last, circular apertures of 120 nm diameter are milled by focused ion beam (FEI Strata DB235). We checked that the metal film roughness remained similar for all adhesion layers used. The roughness was measured to 1.5 nm.

Fluorescence Count Rate per Molecule Calibration. In order to get an accurate understanding of the fluorescence emission in the nanostructure and investigate the influence of the adhesion layer, it is crucial to quantify the fluorescence count rate per molecule CRM, which requires the knowledge of the actual number of emitters, N, contributing to the global fluorescence signal. This issue is addressed via fluorescence correlation spectroscopy (FCS). Zander, C., Enderlein, J., Keller, R. A., Eds. Single-Molecule Detection in Solution: Methods and Applications; Wiley-VCH: Berlin/New York, 2002. In FCS, the temporal fluctuations, F(t), of the fluorescence signal are recorded, and the temporal correlation of this signal is computed g(2)(τ)={F(t)×F(t+τ)}/{F(t)}2, where i is the delay (lag) time, and { } is for time averaging. Analysis of the correlation function provides a measure for the number of molecules, N, needed to compute the count rate per molecule CRM={F}/N. Gerard, D.; Wenger, J.; Bonod, N.; Popov, E.; Rigneault, H.; Mandavi, F.; Blair, S.; Dintinger, J.; Ebbesen, T. W. Nanoaperture-Enhanced Fluorescence: Towards Higher Detection Rates with Plasmonic Metals. Phys. Rev. B 2008, 77, 045413. Wenger, J.; Gerard, D.; Bonod, N.; Popov, E.; Rigneault, H.; Dintinger, J.; Mahboub, 0.; Ebbesen, T. W. Emission and Excitation Contributions to Enhanced Single Molecule Fluorescence by Gold Nanometric Apertures. Opt. Express 2008, 76, 3008-3020. We point out that, as a consequence of the stochastic nature of the FCS technique, all the presented fluorescence data are spatially averaged over all the possible molecule orientations and positions inside the detection volume.

Excitation and Emission Gains Characterization. To unravel the origins of the fluorescence enhancement near a photonic structure, we have developed a specific experimental procedure which has already been applied to the case of fluorescence alteration by gold nanometric apertures. Wenger, J.; Gerard, D.; Bonod, N.; Popov, E.; Rigneault, H.; Dintinger, J.; Mahboub, 0.; Ebbesen, T. W. Emission and Excitation Contributions to Enhanced Single Molecule Fluorescence by Gold Nanometric Apertures. Opt. Express 2008, 76, 3008-3020. This procedure can be summarized as follows: the fluorescence rates per molecule CRM are measured for increasing excitation powers in open solution and in the case of a nanoaperture. The resulting data points are fitted according to the model CRM A(Ie)/(1+Ie/Is), where Ie is the excitation intensity, Is the saturation intensity, and A is a constant proportional to the molecular absorption cross section, quantum yield, and setup collection efficiency. Zander, C., Enderlein, J., Keller, R. A., Eds. Single-Molecule Detection in Solution: Methods and Applications; Wiley-VCH: Berlin/New York, 2002. We deduce from the fits the fluorescence enhancements at the two extreme cases below saturation Ie<<Is and at saturation Ie>>Is. In the saturation regime, the fluorescence rate enhancement is determined only by the gain in emission, 1 lsm. In the low excitation regime, Ie<<Is, the fluorescence enhancement, if is proportional to the gains in emission, ηem, and local excitation intensity, ηexc, and inversely proportional to the gain in total fluorescence decay rate, ηtot: ηF=ηemηexc/ηtot. Using supplementary fluorescence lifetime measurements to determine the alteration in the total fluorescence decay rate, r, it is therefore possible to extract the gain in local excitation intensity from the fluorescence enhancement in the low excitation regime. This unambiguously separates the excitation and emission contributions to the total fluorescence enhancement and is used here to investigate the influence of the adhesion layer on the fluorescence enhancement in single nanoapertures.

Experimental Setup. A comprehensive description of our experimental setup has been presented before. Wenger, J.; Gerard, D.; Bonod, N.; Popov, E.; Rigneault, H.; Dintinger, J.; Mahboub, 0.; Ebbesen, T. W. Emission and Excitation Contributions to Enhanced Single Molecule Fluorescence by Gold Nanometric Apertures. Opt. Express 2008, 76, 3008-3020. Briefly, it is based on a confocal inverted microscope with a NA=1.2 water-immersion objective, allowing single aperture studies (FIG. 2a). For all experiments reported here, we use an aqueous solution of Alexa Fluor 647 fluorescent molecules (A647, Invitrogen, Carlsbad, Calif.) deposited on top of the sample with micromolar concentration. These molecules are constantly diffusing in and out of the aperture, thereby limiting photobleaching. For FCS measurements, the excitation source is a CW He—Ne laser operating at 633 nm. For lifetime measurements, the excitation source is a picosecond laser diode operating at 636 nm (PicoQuant LDH-P-635). A single-mode optical fiber ensures a perfect spatial overlap between the pulsed laser diode and the CW laser. Accurate positioning of the nanoaperture at the laser focus spot is obtained with a multiaxis piezoelectric stage. Single photon detection is performed by avalanche photodiodes with 670±20 nm fluorescence band-pass filters. For FCS, the fluorescence intensity temporal fluctuations are analyzed with a ALV6000 hardware correlator. Each individual FCS measurement is obtained by averaging 10 runs of 10 s duration. For fluorescence lifetime measurements, the photodiode output is coupled to a fast time-correlated single photon counting module (PicoQuant PicoHarp 300).

Numerical Simulations. Numerical analysis is based on the finite element method using COMSOL Multiphysics version 3.3. Mandavi, F.; Liu, Y.; Blair, S. Modeling Fluorescence Enhancement from Metallic Nanocavities. Plasmonics 2007, 2, 129-142. The model considers a computational space of 1.0×1.0×1.1 μm3, with radiation boundary conditions on all faces. A glass substrate is put underneath a 200 nm thick layer of gold plus a 5 or 10 nm adhesion layer, the upper region being water. Gold dielectric properties are incorporated as measured by spectroscopic ellipsometry. Jiao, X.; Goeckeritz, J.; Blair, S.; Oldham, M. Localization of Near-Field Resonances in Bowtie Antennae: Influence of Adhesion Layers. Plasmonics 2009, 4, 37-50. Mandavi, F.; Liu, Y.; Blair, S. Modeling Fluorescence Enhancement from Metallic Nanocavities. Plasmonics 2007, 2, 129-14. A single 120 nm aperture is placed in the center of the metal. To estimate the increase of the excitation intensity inside the aperture, a plane wave at 633 nm is launched incoming from the glass side. Electromagnetic intensity is measured and averaged over the plane 20 nm inside the aperture. This result is then normalized by the integrated intensity with no metal layer. For the emission calculations, a 1 nm dipole is positioned at various locations inside the aperture. Eleven horizontal planes 20 nm apart are considered in the aperture, the very first and very last planes being 5 nm inside the structure. In each horizontal plane, 37 dipole positions are taken. At each point a dipole emitting at 670 nm is aligned along X, Y, and Z directions. The radiative emission through the glass side is estimated by integrating the z-component of Poynting's vector across a plane located 20 nm below the metal surface. This averaged power is then scaled by a fixed normalization factor to fit the experimental emission gain for the chromium adhesion layer.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A detection-enhancement device for biological assay, comprising:
a) a substrate;
b) a metallic layer disposed over the substrate;
c) an array of multiple nanocavities extending into the metallic layer;
d) the nanocavities each having a bottom and a sidewall laterally circumscribing each nanocavity;
e) capture molecules disposed within the nanocavities;
f) the metallic layer having a thickness between 50 to 200 nanometers, and the nanocavities having a lateral dimension of 65 to 190 nanometers;
g) an adhesion layer adhering the metallic layer to the substrate; and
h) a thickness of the adhesion layer and the diameter of the cavity having a ratio in the range of 1:4 to 1:100.

2. A device as in claim 1, wherein the thickness of the adhesion layer and the diameter of the cavity have a ratio in the range of 1:4 to 1:40.

3. A device as in claim 1, wherein the metallic layer comprises gold and the adhesion layer comprises titanium dioxide

4. A device as in claim 1, wherein the thickness of the adhesion layer is between 2 to 15 nanometers.

5. A device as in claim 1, wherein the adhesion layer includes a material selected from the group consisting of: titanium dioxide and chromium oxide and combinations thereof.

6. A device as in claim 1, wherein the metallic layer includes a material selected from the group consisting of: gold, silver, aluminum, or combinations thereof.

7. A device as in claim 1, further comprising a passivation layer disposed over the metallic layer to resist adsorption of a molecule of interest onto the metallic layer.

8. A light enhancement device comprising:
a) a substrate;
b) at least two layers disposed over the substrate, comprising at least a first layer and a second layer;
c) the first layer is disposed closer to the substrate than the second layer;
d) at least one nanocavity extending into the second layer;
e) the first layer having a first layer thickness and a material, the second layer having a second layer thickness and a material, and the at least one cavity having a cavity diameter and a cavity shape adapted to enhance transmission of light through the at least one nanocavity; and
f) the thickness of the first layer and the diameter of the cavity having a ratio that is in the range of approximately 1:4 to 1:100.

9. A device as in claim 8, wherein a ratio of first layer thickness to second layer thickness is in the range of about 1:5 to 1:30.

10. A device as in claim 8, wherein the second layer includes aluminum.

11. A device as in claim 8, wherein the first layer thickness is about 2 to 15 nanometers.

12. A device as in claim 8, wherein the material of the first layer is selected from the group consisting of: titanium dioxide and chromium oxide and combinations thereof.

13. A device as in claim 8, wherein the second layer thickness is about 75 to 125 nanometers.

14. A device as in claim 8, wherein the second layer thickness is less than 75 nanometers and the device further comprising a cover layer disposed on top of the second layer.

15. A device as in claim 8, wherein the material of the second layer is selected from the group consisting of: gold, silver, aluminum, or combinations thereof.

16. A device as in claim 8, wherein the material of the second layer is selected from the group consisting of: gold or silver or combinations thereof; and wherein the diameter of the at least one cavity is about 100 to 140 nanometers.

17. A device as in claim 8, wherein the at least one cavity comprises an array of multiple nanocavities.

18. A device as in claim 8, wherein the at least one cavity is configured to enhance a signal representative of an amount of at least one analyte present in a sample.

19. A device as in claim 8, wherein the at least one cavity comprises a tapered sidewall with an angle, wherein the angle of the tapered sidewall with respect to a surface parallel to the substrate is sufficiently different than 90° to provide an enhancement of the transmission of light through the at least one cavity, an enhancement of the intensity of light within the at least one cavity, or both, that is greater than the enhancement if the angle was 90°.

20. A device as in claim 8, further comprising a passivation layer disposed over the second layer, wherein the passivation layer is capable of preventing adsorption of a molecule of interest onto the second layer.

21. A device as in claim 8, further comprising at least one change in a sidewall within the at least one cavity including a change in angle, a change in material, a change in width, or combinations thereof sufficient to provide an enhancement of the transmission of light through the at least one cavity, an enhancement of the intensity of light within the at least one nanocavity, or both, that is greater than the enhancement without the change in the sidewall.

22. A device as in claim 8, wherein the at least one cavity further extends through the first layer to a top surface of the substrate.

23. A device as in claim 8, wherein the cavity diameter of the at least one cavity is about 65 to 85 nanometers.

24. A device as in claim 8, wherein the cavity diameter of the at least one cavity is about 120 to 160 nanometers.

25. A device as in claim 9, wherein the cavity diameter of the at least one cavity is about 150 to 190 nanometers.

26. A light enhancement device comprising:
a) a substrate;
b) at least two layers disposed over the substrate, comprising at least a first layer and a second layer;
c) the first layer is disposed closer to the substrate than the second layer;
d) an array of multiple nanocavities extending into the second layer;
e) the first layer having a first layer thickness and a material, the second layer having a second layer thickness and a material, the at least one cavity having a cavity diameter and a cavity shape adapted to enhance transmission of light through the at least one nanocavity; and
f) the first layer causes an improvement in light transmission by a factor of at least 3.

27. A detection-enhancement device for biological assay, comprising:
a) a substrate;
b) a metallic layer disposed over the substrate;
c) an array of multiple nanocavities extending into the metallic layer;
d) the nanocavities each having a bottom and a sidewall laterally circumscribing each nanocavity;
e) capture molecules disposed within the nanocavities;
f) the metallic layer having a thickness between 50 to 200 nanometers, and the nanocavities having a lateral dimension of 65 to 190 nanometers;
g) an adhesion layer adhering the metallic layer to the substrate; and
h) a blocking layer disposed over the metallic layer including a material to resist light transmitting through the metallic layer.
